(19) United States
(12) Patent Application Publication
(10) Pub. No.: US 2025/0362845 A1
(43) Pub. Date: Nov. 27, 2025

(54) PRINTER CONFIGURED TO PERFORM POWER SUPPLY INITIATION PROCESS ON THE BASIS OF POWER STATE OF PRINTER TO CAUSE POWER DELIVERY CIRCUIT TO INITIATE SUPPLY OF POWER TO EXTERNAL DEVICE

(71) Applicant: BROTHER KOGYO KABUSHIKI KAISHA, Nagoya (JP)

(72) Inventors: Shuhei YAMAKAMI, Nagoya (JP); Yuki HIRAMATSU, Nukata (JP); Guowei CHAI, Nagoya (JP); Takaaki NAKAO, Nagoya (JP); Atsushi FUJIOKA, Nagoya (JP)

(21) Appl. No.: 19/219,586

(22) Filed: May 27, 2025

(30) Foreign Application Priority Data
May 27, 2024 (JP) 2024-085512

(51) Int. Cl. G06F 3/12

(52) U.S. Cl. CPC G06F 3/1229; G06F 3/1221; G06F 3/1236; G06F 3/1292

(57) ABSTRACT

A printer includes: a Universal Serial Bus (USB) connector to which an external device is connectable; a Power Delivery (PD) circuit; and a processor. The PD circuit is configured to perform a negotiation with the external device according to a Universal Serial Bus Power Delivery (USB-PD) specification in a state where the external device is connected to the USB connector. The processor is configured to perform a power supply initiation process on the basis of a power state of the printer. The power supply initiation process includes outputting a source setting instruction to the PD circuit to cause the PD circuit to initiate supply of power to the external device. The source setting instruction instructs the PD circuit to switch a power role of the printer with respect to the external device from sink to source.

### REFERENCE TO RELATED APPLICATIONS

This application claims priority from Japanese Patent Application No. 2024-085512 filed on May 27, 2024. The entire content of the priority application is incorporated herein by reference.

### BACKGROUND ART

There has been known a printer including a Universal Serial Bus (USB) interface having a connector and a current detector. The printer is configured to deliver power to an external device through the USB interface. When the printer receives an instruction instructing to perform an image process while supplying power to an external device, the printer determines whether the difference between minimum and maximum values of current detected by the USB interface within a fixed period while supplying power to the external device exceeds a threshold value.

When the difference between the minimum and maximum values of detected current exceeds the threshold value, the printer outputs an instruction to the USB interface instructing to restrict power supply to the external device. On the other hand, when the printer determines that the difference between the minimum and maximum values of current detected by the current detector within the fixed period does not exceed the threshold value, the printer does not output an instruction to the USB interface instructing to restrict the power supply to the external device. According to the Universal Serial Bus Power Delivery (USB-PD) specification, the printer performs a negotiation with the external device connected to the printer through the connector and sets the direction and magnitude of power delivery based on the results of the negotiation.

### SUMMARY

However, as a result of the negotiation between the printer described above and the external device connected to the printer via the connector, the printer may initiate supply of power to the external device in an unintended power state (for example, in a state where the printer is not connected to an external power source through an AC adapter).

In view of the foregoing, it is an object of the present disclosure to provide a printer that can reduce the possibility in which power supply to an external device connected to the printer via a connector is started while the printer is in an unintended power state more reliably than known printers.

In order to attain the above and other objects, the present disclosure provides a printer including: a Universal Serial Bus (USB) connector to which an external device is connectable; a Power Delivery (PD) circuit; and a processor. The PD circuit is configured to perform a negotiation with the external device according to a Universal Serial Bus Power Delivery (USB-PD) specification in a state where the external device is connected to the USB connector. The processor is configured to perform a power supply initiation process on the basis of a power state of the printer. The power supply initiation process includes outputting a source setting instruction to the PD circuit to cause the PD circuit to initiate supply of power to the external device. The source setting instruction instructs the PD circuit to switch a power role of the printer with respect to the external device from sink to source.

According to the USB-PD specification, the printer does not supply power to the external device in a state where the power role of the printer with respect to the external device is sink. In the power supply initiation process executed by the processor of the printer, the processor outputs the source setting instruction to cause the PD circuit to initiate the supply of power to the external device when the power state of the printer is brought into an intended state (for example, when the printer is connected to an external power source), but sets the power role of the printer to sink in a state where the printer is in an unintended power state (for example, in a state where the printer is not connected to the external power source). Accordingly, performing the power supply initiation process can reduce the possibility in which the printer starts to supply power to the external device while in an unintended power state more reliably than the known technology.

### BRIEF DESCRIPTION OF DRAWINGS

FIG. 1 is a perspective view of a printer 1 in which a cover 22 is in its closed state as viewed from the right-front-upper side thereof.

FIG. 2 is a partial cross-sectional view of the printer 1 taken along line II-II in FIG. 1.

FIG. 3 is a block diagram illustrating the electrical configuration in the printer 1.

FIG. 4 is a flowchart illustrating steps in a printing control process.

FIG. 5 is a flowchart illustrating steps in a power supply initiation control process.

FIG. 6 illustrates transitions of the power role of the printer 1.

FIG. 7 is a flowchart illustrating steps in a power supply termination control process.

### DESCRIPTION

Hereinafter, an embodiment of the present disclosure will be described while referring to the accompanying drawings. The referenced drawings are used to describe the technical features made possible with the present disclosure. In other words, the configurations and the like illustrated in the drawings are merely illustrative examples and is not intended to limit the present disclosure.

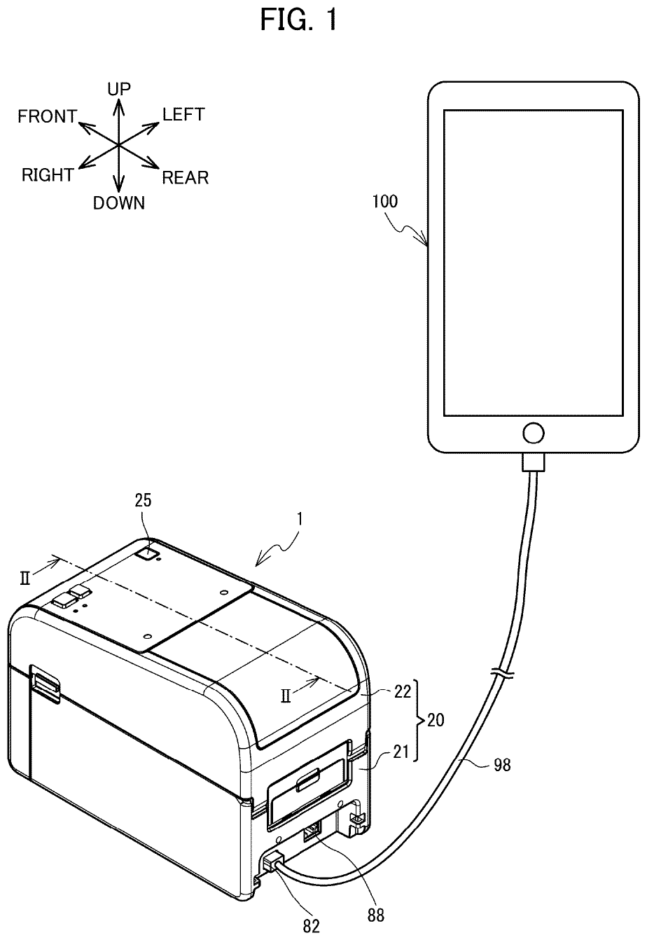

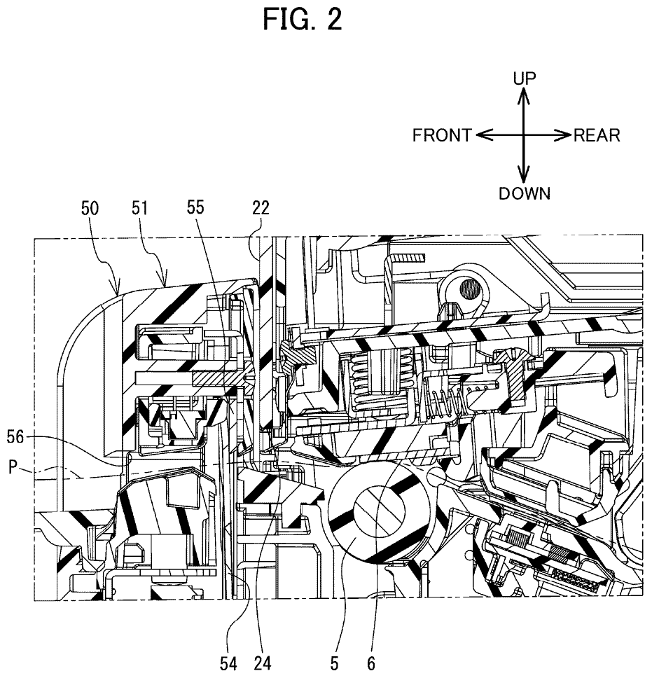

The physical configuration of a printer 1 will be described with reference to FIGS. 1 and 2. In the following description, the upper-left side, the lower-right side, the lower-left side, the upper-right side, the upper side, and the lower side in FIG. 1 will be defined as the front side, the rear side, the right side, the left side, the upper side, and the lower side of the printer 1, respectively. In the present embodiment, an up-down direction, for example, is used to facilitate the description and is not limited to the vertical direction.

As illustrated in FIGS. 1 and 2, the printer 1 is a thermal printer configured to perform printing on a printing medium P. The printing medium P in the present embodiment is a long, continuous printing tape whose length in a conveying direction is greater than its length in a width direction. The width direction is parallel to a left-right direction, and the conveying direction is parallel to a frontward direction. The printer 1 includes a housing 20, and an input unit 25. The housing 20 includes a body portion 21, and a cover 22.

The body portion 21 has a substantially rectangular parallelepiped box shape that is elongated in a front-rear direction, and constitutes a lower portion of the housing 20. The body portion 21 has an opening open upward. The cover 22 has a substantially rectangular parallelepiped box shape that is elongated in the front-rear direction, and constitutes an upper portion of the housing 20. The cover 22 is pivotally movable about an axis extending in the left-right direction and arranged at an upper-rear edge of the body portion 21. FIG. 1 illustrates the cover 22 in its closed state. In this state, the cover 22 covers the opening of the body portion 21 from above. Although not illustrated in the drawings, the opening of the body portion 21 is exposed upward in a state where the cover 22 is in its open state.

As illustrated in FIG. 2, a front end of the housing 20 has a discharge opening 24. The discharge opening 24 is a gap formed between a front wall of the body portion 21 and a front wall of the cover 22, and extends in the left-right direction. The printing medium P on which printing has been performed is to be discharged out of the housing 20 through the discharge opening 24.

As illustrated in FIG. 1, the input unit 25 is arranged at an upper end portion of the cover 22. The input unit 25 includes switches configured to receive input of various information and various instructions and to output the inputted information and instructions to a CPU 30 (described later). The input unit 25 includes a power button.

As illustrated in FIG. 2, the printer 1 further includes a conveying unit 5, and a print head 6. The conveying unit 5 and the print head 6 are disposed inside the housing 20. The conveying unit 5 is disposed at a front-upper end in the body portion 21. The conveying unit 5 is arranged between a front end of the body portion 21 and a front end of a support mechanism (not shown) in the front-rear direction. The conveying unit 5 is a cylinder having an axis extending in the left-right direction. The conveying unit 5 is arranged in the body portion 21 so as to be rotatable about the axis. That is, the conveying unit 5 is a conveying roller in the present embodiment.

The print head 6 is configured to perform printing on media P. The print head 6 has a plate shape that extends in the left-right direction. The print head 6 is mounted in the cover 22 from below. In the present embodiment, the print head 6 is a thermal head having a plurality of heating elements. The printer 1 performs printing on media P by heating selected one or more heating elements of the pluralities of heating elements in the print head 6.

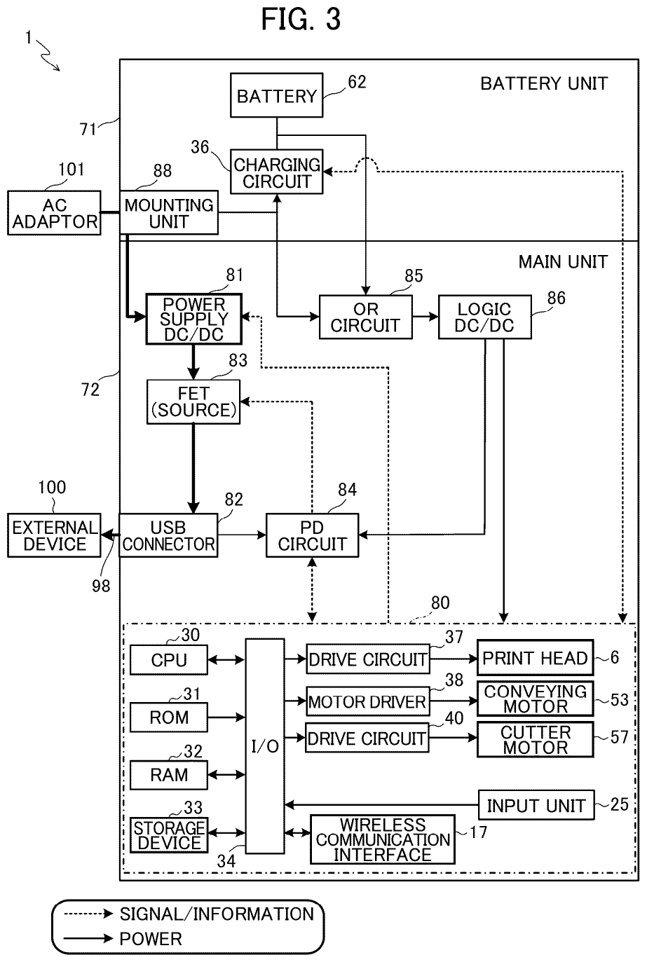

A cutter unit 50 is attached to the front end of the housing 20 so as to be detached therefrom. The cutter unit 50 includes a unit housing 51, a cutting blade 54, a fixed blade 55, and a cutter motor 57 illustrated in FIG. 3. The unit housing 51 has a rectangular parallelepiped box shape. The unit housing 51 has a passage opening 56 that extends through the unit housing 51 in the front-rear direction. A rear end of the passage opening 56 is positioned frontward of the discharge opening 24.

The cutting blade 54 and the fixed blade 55 are accommodated in the unit housing 51. Specifically, the cutting blade 54 and the fixed blade 55 are arranged in a rear end portion of the unit housing 51. The fixed blade 55 is disposed above the passage opening 56, and is fixed to the unit housing 51. A cutting edge of the fixed blade 55 constitutes a lower edge of the same. The cutting edge of the fixed blade 55 extends in the left-right direction. The cutting edge of the fixed blade 55 is exposed in the passage opening 56 from above.

The cutting blade 54 is disposed below the passage opening 56 and extends in the left-right direction. A cutting edge of the cutting blade 54 constitutes an upper edge of the cutting blade 54. The cutting blade 54 is supported by the unit housing 51 so as to be movable between a retracted position (see FIG. 2) in which the cutting blade 54 is retracted below the passage opening 56, and an advanced position in which the cutting blade 54 is advanced into the passage opening 56. The cutter motor 57 is accommodated in the unit housing 51. The cutter motor 57 is configured to move the cutting blade 54 between the retracted position and the advanced position. The printer 1 is configured to control the cutter motor 57 to move the cutting blade 54 from the retracted position to the advanced position for cutting a printing medium P that has been discharged through the discharge opening 24 between the cutting blade 54 and the fixed blade 55.

The electrical configuration of the printer 1 will be described next with reference to FIG. 3. The printer 1 further includes a battery unit 71, and a main unit 72. The battery unit 71 includes a charging circuit 36, a battery 62, and a mounting unit 88. In a state where an AC adapter 101 is connected to the mounting unit 88, the charging circuit 36 charges the battery 62 with power received from the AC adapter 101. Power is supplied to a drive unit 80 from either the AC adapter 101 or the battery 62. The drive unit 80 is configured to perform printing on a printing medium P using power from the AC adapter 101 or the battery 62. The battery 62 is a lithium-ion battery or an electric double-layer capacitor, for example.

Although not illustrated in the drawings in detail, the AC adapter 101 is connected to an external power source such as a commercial power supply. Accordingly, in the following description, it is assumed that the AC adapter 101 connected to the printer 1 serves as the external power source for suppling power to the printer 1.

The main unit 72 includes an OR circuit 85, a DC-to-DC converter for logic 86 (hereinafter referred to as “logic DC/DC”), a DC-to-DC converter for Universal Serial Bus (USB) power supply 81 (hereinafter referred to as “power supply DC/DC”), an FET 83, a USB connector 82, a Power Delivery (PD) circuit 84, and the drive unit 80.

The OR circuit 85 is configured to switch the power supply path to the drive unit 80, depending on whether the battery 62 and the AC adapter 101 are connected to the printer 1. In a case where only the AC adapter 101 is connected, for example, the OR circuit 85 switches the power supply path to supply power from the AC adapter 101. In a case where only the battery 62 is connected, the OR circuit 85 switches the power supply path to supply power from the battery 62. In a case where both the AC adapter 101 and the battery 62 are connected, the OR circuit 85 switches the power supply path to supply power from the AC adapter 101 to the drive unit 80 while also supplying power to the battery 62 from the AC adapter 101, for example. The process for switching the power supply path is executed automatically by the OR circuit 85, but may also be performed by the user.

The logic DC/DC 86 is configured to convert an input voltage from the AC adapter 101 or the battery 62 to an output voltage for driving the drive unit 80 (e.g., 3.3 V).

The power supply DC/DC 81 is configured to convert the input voltage from the AC adapter 101 to an output voltage suitable for supplying power to the external device 100 (e.g., 9 V or 5 V). Power converted by the power supply DC/DC 81 is supplied to the external device 100.

The external device 100 is connectable to the USB connector 82. The USB connector 82 is a connection port for connecting the external device 100 to the printer 1 via a cable 98 that conforms to the Universal Serial Bus Power Delivery (USB-PD) specification. The external device 100 is a USB device.

The PD circuit 84 is configured to perform a negotiation with the external device 100 connected to the USB connector 82 in conformance with the USB-PD specification. The PD circuit 84 is configured to communicate with a CPU 30 of the drive unit 80. The PD circuit 84 is configured to control the magnitude of the output voltage outputted from the power supply DC/DC 81. The PD circuit 84 is configured to perform a negotiation with the external device 100 via the USB connector 82 in conformance with the USB-PD specification.

The PD circuit 84 is configured to control the supply of power from the power supply DC/DC 81 to the external device 100 by turning the FET 83 on and off. As the PD circuit 84 turns on the FET 83, for example, power is supplied to the external device 100 via the USB connector 82 and the cable 98. In other words, the PD circuit 84 is configured to supply power to the external device 100 using the power supplied by the AC adapter 101.

The drive unit 80 includes the CPU 30, a ROM 31, a RAM 32, a storage device 33, and an input/output (I/O) interface 34. Note that the I/O interface 34 is abbreviated as “I/O” in FIG. 3. The CPU 30, the ROM 31, the RAM 32, and the storage device 33 are electrically connected to the I/O interface 34. The CPU 30 is a processor configured to control the printer 1. The ROM 31 stores various settings information. The RAM 32 temporarily stores various information. The storage device 33 is nonvolatile.

The I/O interface 34 is also connected to drive circuits 37 and 40, a motor driver 38, the input unit 25, and a wireless communication interface 17. The drive circuit 37 is configured to control driving of the print head 6 in response to instructions inputted from the CPU 30. The drive circuit 40 is configured to control driving of the cutter motor 57 in response to instructions inputted from the CPU 30. The motor driver 38 is configured to control driving of a conveying motor 53 in response to instructions inputted from the CPU 30. The input unit 25 is configured to input detection results into the I/O interface 34.

The wireless communication interface 17 is a communication interface configured to perform short-range wireless communications in conformance with the Bluetooth standard, for example. The communication standard used by the wireless communication interface 17 is not limited to the Bluetooth standard but may be another short-range wireless communication standard, such as NFC (near-field communication). The wireless communication interface 17 may be configured to communicate with external devices according to the Wi-Fi Direct standard (abbreviated as WFD) developed by the Wi-Fi Alliance, for example. “Bluetooth” is a registered Japanese trademark of Bluetooth Special Interested Group, Inc. “Wi-Fi Direct” is a registered Japanese trademark of Wi-Fi Alliance.

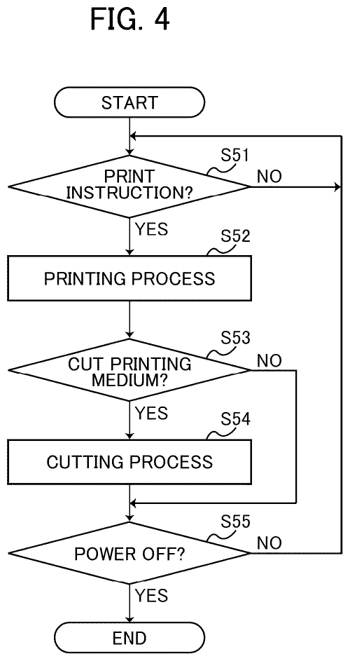

Next, a printing control process executed by the printer 1 will be described with reference to FIG. 4. In the following description, steps are abbreviated as “S”. After the printer 1 is turned on, the CPU 30 reads a program stored in the ROM 31 for executing the printing control process into the RAM 32. The CPU 30 executes the printing control process having the following steps in accordance with instructions contained in the program read into the RAM 32. Various data obtained during the course of the printing control process is stored in the RAM 32 as appropriate. In a state where the AC adapter 101 is connected to the printer 1, the printer 1 sets the power supply for the printer 1 to the AC adapter 101 regardless of whether a battery 62 is mounted in the printer 1. In a state where the AC adapter 101 is not connected to the printer 1, the printer 1 sets the power supply for the printer 1 to the battery 62.

As illustrated in FIG. 4, in S51 the CPU 30 determines whether a print instruction instructing the printer 1 to perform printing has been detected. The user inputs a print instruction into the printer 1 by operating the input unit 25. A print instruction may also be inputted from an external device via the wireless communication interface 17. A print instruction includes print data and cutting information indicating whether the printing medium P is to be cut after printing has been performed. The CPU 30 continues to repeat the determination in S51 while a print instruction inputted through the input unit 25 or the wireless communication interface 17 (S51: NO) has not been detected.

When a print instruction has been detected (S51: YES), in S52 the CPU 30 executes a printing process by driving the print head 6 and the conveying unit 5 to perform printing on the printing medium P. Specifically, the CPU 30 outputs a control signal to the motor driver 38. The motor driver 38 drives the conveying motor 53 to rotate the conveying unit 5 by outputting a drive current corresponding to the control signal received from the CPU 30. Accordingly, the conveying unit 5 draws the printing medium P off a roll. The printer 1 also outputs a control signal to the drive circuit 37. The drive circuit 37 controls the print head 6 to heat selected heating elements. Color is produced in areas of the printing medium P that are heated by the heating elements. The printer 1 repeatedly performs conveying of the printing medium P a prescribed amount with the conveying unit 5 and heating of the printing medium P with the print head 6, thereby performing printing on the printing medium P. The printing medium P on which printing has been performed is then discharged out of the housing 20 through the discharge opening 24 and is inserted through the passage opening 56.

In S53 the CPU 30 determines whether the printing medium P is to be cut based on the cutting information included in the print instruction. When the printing medium P is to be cut (S53: YES), in S54 after the printing process has been completed, the printer 1 executes a cutting process to drive the cutting blade 54 for cutting the printing medium P while the conveying unit 5 is halted. Specifically, the CPU 30 stops the conveying unit 5 when the printing medium P has been conveyed to a cutting position and outputs a control signal to the drive circuit 40. The drive circuit 40 drives the cutter motor 57 by outputting a drive current corresponding to the control signal received from the CPU 30. The cutter motor 57 moves the cutting blade 54 upward and downward, whereby the printer 1 causes the printing medium P that has been discharged through the discharge opening 24 to be cut between the cutting blade 54 and the fixed blade 55.

When the printing medium P is not to be cut (S53: NO) or after completing the cutting process of S54, in S55 the CPU 30 determines whether the printer 1 is to be turned off. When the printer 1 is not to be turned off (S55: NO), the CPU 30 returns to the process of S51. When the printer 1 is to be powered off (S55: YES), the CPU 30 ends the printing control process at that point.

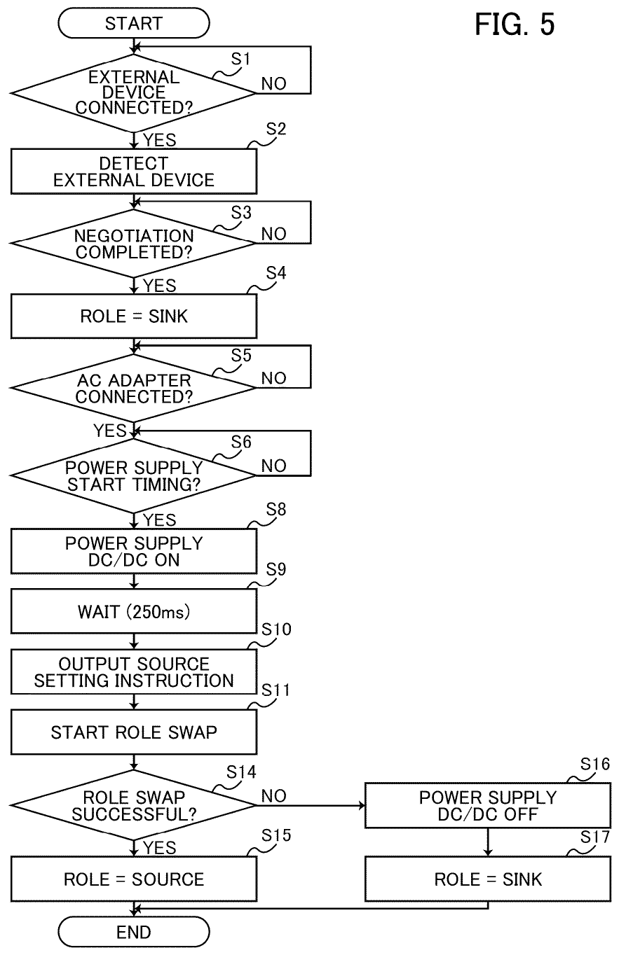

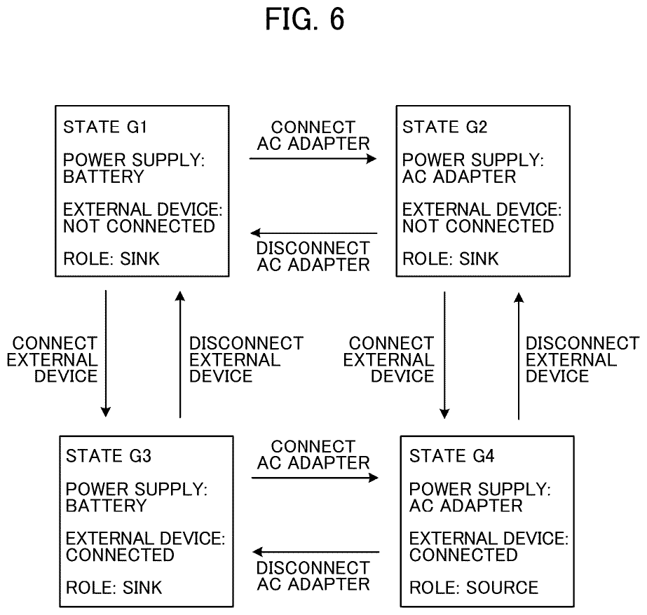

Next, a power supply initiation control process executed on the printer 1 will be described with reference to FIGS. 5 and 6. In the following description, step will be abbreviated as “S”. When the printer 1 is turned on, the CPU 30 reads a program stored in the ROM 31 for executing the power supply initiation control process into the RAM 32. The CPU 30 executes the power supply initiation control process having the following steps in accordance with instructions contained in the program read into the RAM 32. Various data obtained during the course of the power supply initiation control process is stored in the RAM 32 as appropriate.

In S1 of FIG. 5, the CPU 30 determines whether the external device 100 is connected to the USB connector 82. The CPU 30 continues to repeat the determination in S1 while an external device 100 is not connected to the USB connector 82 (S1: NO). When the external device 100 is connected to the USB connector 82 while the battery 62 is used as the power supply i.e., while the printer 1 is in a state G1 of FIG. 6 (S1: YES), in S2 the CPU 30 detects the external device 100, and the PD circuit 84 performs a negotiation, in compliance with the USB-PD specification, with the external device 100 through the USB connector 82.

In S3 the CPU 30 determines whether the PD circuit 84 has completed the negotiation with the external device 100. When the negotiation has been completed, the PD circuit 84 notifies the CPU 30 of the results of the negotiation. While the negotiation has not been completed (S3: NO), the CPU 30 continues to repeat the determination in S3. After the negotiation has been completed (S3: YES), in S4 the PD circuit 84 sets the initial power role of the printer 1 to sink.

In S5 the CPU 30 determines whether the AC adapter 101 is connected to the mounting unit 88. The process of S5 is performed for determining whether the connection state of the printer 1 to the AC adapter 101 (i.e., the connection state of the printer 1 to the external power source) meets a source setting condition. In the present embodiment, the source setting condition is determined met when the CPU 30 determines that the AC adapter 101 has been connected to the printer 1 while the external device 100 is connected to the printer 1 via the USB connector 82 (S5: YES after S5: NO). The source setting condition is also determined met when the external device 100 is connected to the printer 1 via the USB connector 82 while the AC adapter 101 is connected to the printer 1 (S5: YES without a previous S5: NO).

While the AC adapter 101 has not been connected to the mounting unit 88, as in a state G3 of FIG. 6 (S5: NO), the CPU 30 repeats the determination of S5 until the AC adapter 101 is connected. When the AC adapter 101 has been connected to the mounting unit 88, as in a state G4 of FIG. 6 (S5: YES), in S6 the CPU 30 determines whether a power supply start timing at which the printer 1 can begin supply of power to the external device 100 has arrived. The power supply start timing may be set as appropriate. For example, the power supply start timing may be set according to at least one of the following first through sixth start conditions. The first through sixth start conditions may be combined to the extent that they are not contradictory.

According to the first start condition, when the connection state of the printer 1 to the AC adapter 101 meets the source setting condition (S5: YES) while the CPU 30 executes a printing process in S52, the CPU 30 determines that the power supply start timing has not arrived while the printing process is in progress (S6: NO) and determines that the power supply start timing has arrived after the printing process has been completed (S6: YES).

According to the second start condition, when the connection state of the printer 1 to the AC adapter 101 meets the source setting condition (S5: YES) while the CPU 30 executes a printing process in S52, the CPU 30 determines that the power supply start timing has not arrived while the printing process is in progress (S6: NO) and determines that the power supply start timing has arrived when the CPU 30 executes a cutting process of S54 after completing the printing process (S6: YES).

According to the third start condition, when the connection state of the printer 1 to the AC adapter 101 meets the source setting condition (S5: YES) while the CPU 30 executes a printing process in S52, the CPU 30 determines that the power supply start timing has not arrived while the printing process is in progress (S6: NO) and determines that the power supply start timing has arrived between print jobs, i.e., after the printing process in progress has been completed and before the next printing process has started (S6: YES).

According to the fourth start condition, when the connection state of the printer 1 to the AC adapter 101 meets the source setting condition (S5: YES) while the CPU 30 executes a printing process in S52, the CPU 30 determines that the power supply start timing has not arrived while the printing process is in progress (S6: NO) and determines that the power supply start timing has arrived between print jobs, i.e., after the printing process based on the current print instruction received through the wireless communication interface 17 has been completed and before the next print instruction is received via the wireless communication interface 17 (S6: YES).

According to the fifth start condition, when the connection state of the printer 1 to the AC adapter 101 meets the source setting condition (S5: YES) while the print head 6 is being driven, the CPU 30 determines that the power supply start timing has not arrived while the print head 6 is being driven (S6: NO) and determines that the power supply start timing has arrived after driving of the print head 6 has been completed (S6: YES). With the fifth start condition, the power supply start timing may be set to a timing at which the print head 6 is not being driven, even while a printing process is in progress.

According to the sixth start condition, when the connection state of the printer 1 to the AC adapter 101 meets the source setting condition (S5: YES) while the conveying unit 5 is being driven, the CPU 30 determines that the power supply start timing has not arrived while the conveying unit 5 is being driven (S6: NO) and determines that the power supply start timing has arrived after driving of the conveying unit 5 has been completed (S6: YES). With the sixth start condition, the power supply start timing may be set to a timing at which the conveying unit 5 is not being driven, even while a printing process is in progress. With the sixth start condition, the power supply start timing is not set to a timing at which the conveying unit 5 is being driven, even if a printing process is not in progress.

The CPU 30 continues to repeat the determination in S6 while the power supply start timing has not arrived (S6: NO). When the power supply start timing has arrived (S6: YES), in S8 the CPU 30 outputs an ON signal to the power supply DC/DC 81. In S9 the CPU 30 waits 250 millisecond, and then in S10 executes a power supply initiation process on the basis of the power state of the printer 1. In the power supply initiation process, the CPU 30 outputs a source setting instruction to the PD circuit 84 instructing to switch the power role of the printer 1 with respect to the external device 100 from sink to source to thereby initiate the supply of power to the external device 100. In the present embodiment, when the connection state of the printer 1 to the AC adapter 101 meets the source setting condition (S5: YES), in S10 the CPU 30 outputs a source setting instruction to the PD circuit 84 at the power supply start timing to start the supply of power to the external device 100. Note that the “power state of the printer 1” indicated herein denotes the state of power supply to the printer 1 from an external power source. As described above, the external power source is the AC adapter 101 in the present embodiment.

In response to obtaining a source setting instruction from the CPU 30, in S11 the PD circuit 84 performs a negotiation with the external device 100 to begin a role swap for changing the power role of the printer 1 from sink to source. In S14 the CPU 30 determines whether the power role swap was successful. Upon completing a negotiation, the PD circuit 84 outputs the results of the negotiation to the CPU 30. When the power role swap was successful (S14: YES), in S15 the PD circuit 84 changes the power role of the printer 1 from sink to source, as indicated by the state G4 in FIG. 6. In this case, the power supply DC/DC 81 begins the supply of power to the external device 100.

On the other hand, when the source setting (i.e., the power role swap) failed (S14: NO), in S16 the CPU 30 outputs an OFF signal to the power supply DC/DC 81. In S17 the PD circuit 84 maintains the power role of the printer 1 at sink. In this case, the power supply DC/DC 81 does not begin the supply of power to the external device 100. Following the process of S15 or S17, the CPU 30 starts a power supply termination control process, thereby completing the power supply initiation control process.

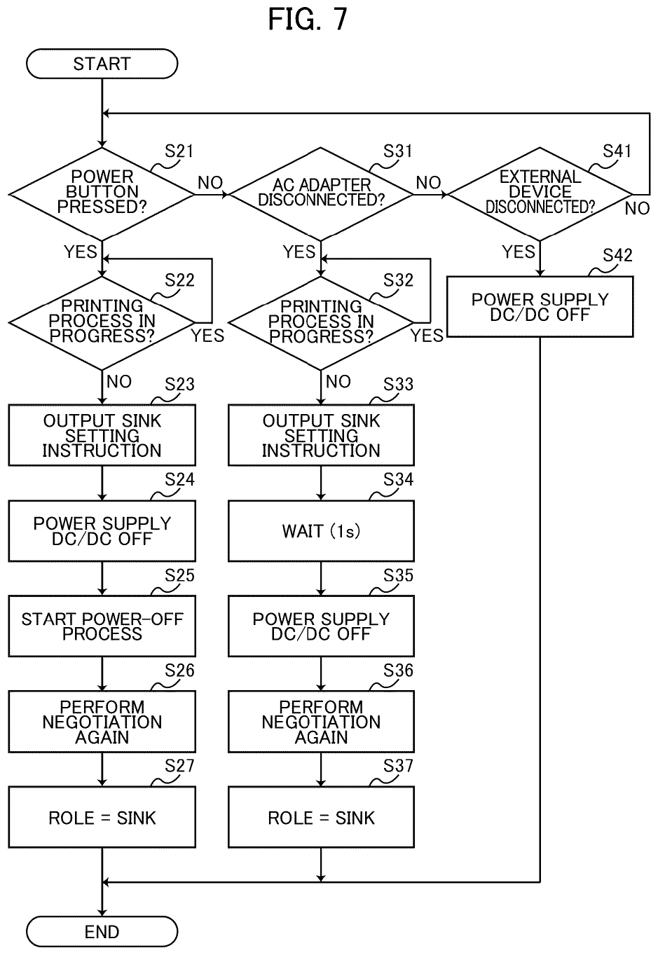

Next, the power supply termination control process executed on the printer 1 will be described with reference to FIG. 7. In the power supply termination control process, the CPU 30 executes a power supply termination process on the basis of the power state of the printer 1. In the power supply termination process, the CPU 30 outputs a sink setting instruction to the PD circuit 84 for switching the power role of the printer 1 with respect to the external device 100 from source to sink to halt the supply of power to the external device 100. In the following description, steps will be abbreviated as “S”. After ending the power supply initiation control process, the CPU 30 reads a program stored in the ROM 31 for executing the power supply termination control process into the RAM 32. The CPU 30 executes the power supply termination control process having the following steps in accordance with instructions contained in the program read into the RAM 32. Various data obtained during the course of the power supply termination control process is stored in the RAM 32 as appropriate.

In S21 of FIG. 7, the CPU 30 determines whether the power button was pressed based on detection results of the input unit 25. The user presses the power button to turn off the power supply to the printer 1. When the power button was pressed (S21: YES), in S22 the CPU 30 determines whether a printing process is in progress. When a printing process is in progress (S22: YES), the CPU 30 waits at S22 until the printing process is completed.

When the CPU 30 obtains a power-off instruction to turn off the printer 1 (S21: YES) while a printing process is not in progress (S22: NO), in S23 the CPU 30 outputs a sink setting instruction to the PD circuit 84 to switch the power role of the printer 1 with the external device 100 from source to sink, thereby terminating the power supply to the external device 100. When the power state of the printer 1 meets a condition for outputting a sink setting instruction during a printing process (S22: YES), in S23 the CPU 30 in the present embodiment outputs a sink setting instruction to the PD circuit 84 after the printing process has been completed (S22: NO) to cause the PD circuit 84 to terminate the power supply to the external device 100. That is, in the power supply termination control process, the CPU 30 determines that the power state of the printer 1 meets a condition for outputting a sink setting instruction when obtaining a power-off instruction. In S24 the CPU 30 outputs an OFF signal to the power supply DC/DC 81. Upon obtaining the OFF signal from the CPU 30, the power supply DC/DC 81 stops the supply of power to the external device 100.

In S25 the CPU 30 starts to shut off the power supply to the main unit 72 of the printer 1. In the present embodiment, when the CPU 30 obtains a power-off instruction to turn off the power supply while a printing process is in progress (S22: YES), the CPU 30 executes a power-off process in S25 to turn off the power supply to the printer 1 after the printing process has been completed (S22: NO).

In response to obtaining a sink setting instruction in S23, in S26 the PD circuit 84 performs a negotiation with the external device 100 again and in S27 sets the power role of the printer 1 to sink. Through the process of S27, the printer 1 terminates the supply of power from the power supply DC/DC 81 to the external device 100. The CPU 30 then ends the power supply termination process at this point.

On the other hand, when the power button was not pressed (S21: NO), in S31 the CPU 30 determines whether the AC adapter 101 was unplugged from the mounting unit 88 while the printer 1 is in the state G4 in FIG. 6. When the AC adapter 101 was unplugged (S31: YES), in S32 the CPU 30 determines whether a printing process is in progress. When a printing process is in progress (S32: YES), the CPU 30 waits at S32 until the printing process is completed.

When a printing process is not in progress (S32: NO), in S33 the CPU 30 outputs a sink setting instruction to the PD circuit 84. In the present embodiment, when the power state of the printer 1 meets a condition for outputting a sink setting instruction (S31: YES) while a printing process is in progress, in S33 the CPU 30 outputs a sink setting instruction to the PD circuit 84 after the printing process has been completed (S31: NO) to cause the PD circuit 84 to terminate the supply of power to the external device 100. That is, the CPU 30 determines that a condition for outputting a sink setting instruction is met when the printer 1 is disconnected from the AC adapter 101. In S34 the CPU 30 waits 1 second and then in S35 outputs an OFF signal to the power supply DC/DC 81. In response to obtaining an OFF signal from the CPU 30, the power supply DC/DC 81 stops the supply of power to the external device 100.

Upon obtaining a sink setting instruction in S33, in S36 the PD circuit 84 performs a negotiation again with the external device 100 and in S37 sets the power role of the printer 1 to sink, as indicated by the state G3 in FIG. 6. Through the process of S37, the printer 1 terminates the power supply from the power supply DC/DC 81 to the external device 100.

On the other hand, when the AC adapter 101 was not unplugged (S31: NO), in S41 the CPU 30 determines whether the external device 100 was unplugged from the USB connector 82. When the external device 100 was not unplugged from the USB connector 82 (S41: NO), the CPU 30 returns to the process in S21. When the external device 100 was unplugged from the USB connector 82 (S41: YES), in S42 the CPU 30 outputs an OFF signal to the power supply DC/DC 81. As a result, the power role of the printer 1 is returned to the initial value of sink, as indicated by a state G2 in FIG. 6. Following the process of S37 or S42, the CPU 30 begins the power supply initiation control process and ends the power supply termination control process at this point.

The printer 1 according to the embodiment described above includes the USB connector 82 to which the external device 100 is connectable, the PD circuit 84 configured to perform a negotiation with the external device 100 according to the USB-PD specification in a state where the external device 100 is connected to the USB connector 82, and the CPU 30. On the basis of the power state of the printer 1, the CPU 30 is configured to perform a power supply initiation process (S10). In the power supply initiation process, the CPU 30 outputs a source setting instruction to the PD circuit 84 to cause the PD circuit 84 to initiate the supply of power to the external device 100. The source setting instruction instructs the PD circuit 84 to switch the power role of the printer 1 with respect to the external device 100 from sink to source.

According to the USB-PD specification, the printer 1 does not supply power to the external device 100 in a state where the power role of the printer 1 with respect to the external device 100 is sink. In the power supply initiation process executed by the CPU 30 of the printer 1, the CPU 30 supplies power to the external device 100 by outputting a source setting instruction when the power state of the printer 1 is brought into an intended state (e.g., when the printer 1 is connected to the external power source through the AC adapter 101) but sets the power role of the printer 1 to sink in a state where the printer 1 is in an unintended power state (e.g., in a state where the printer 1 is not connected to the external power source through the AC adapter). Accordingly, the power supply initiation process can reduce the possibility in which the printer 1 starts to supply power to the external device 100 in an unintended power state more reliably than the known technology.

The power state of the printer 1 is determined based on the connection state of the printer 1 to the AC adapter (i.e., the external power source). When the connection state of the printer 1 to the AC adapter 101 meets the source setting condition (S5: YES), the CPU 30 performs the power supply initiation process. That is, the CPU 30 outputs a source setting instruction to the PD circuit 84 to begin the supply of power to the external device 100 (S10). By outputting a source setting instruction based on the connection state of the printer 1 to the AC adapter 101, the power supply initiation process executed by the CPU 30 of the printer 1 reduces the possibility in which the supply of power to the external device 100 is started in a state where the connection state of the printer 1 to the AC adapter 101 is an unintended state more reliably than the known technology.

When the printer 1 is connected to the AC adapter 101 (i.e., the external power source) in a state where the external device 100 is connected to the printer 1 through the USB connector 82 (S5: YES after S5: NO), the CPU 30 determines that the source setting condition is met and performs the power supply initiation process (S10). When the AC adapter 101 is connected to the printer 1 in a state where the external device 100 is connected to the printer 1 through the USB connector 82, the printer 1 can stably supply power to the external device 100 using the AC adapter 101 as the power supply. With the power supply initiation process executed by the CPU 30 of the printer 1, the CPU 30 can initiate power supply to the external device 100 by automatically switching the power role of the printer 1 relative to the external device 100 from sink to source when the printer 1 can supply stable power to the external device 100.

When the external device 100 is connected to the printer 1 through the USB connector 82 in a state where the printer 1 is connected to the AC adapter 101 (i.e., the external power source) (S5: YES without previously S5: NO), the CPU 30 determines that the source setting condition is met and performs the power supply initiation process (S10). When the external device 100 is connected to the printer 1 through the USB connector 82 in a state where the AC adapter 101 is connected to the printer 1, the printer 1 can supply stable power to the external device 100 using the AC adapter 101 as the power supply. By performing the power supply initiation process, the CPU 30 of the printer 1 can initiate the supply of power to the external device 100 by automatically switching the power role of the printer 1 relative to the external device 100 from sink to source when the printer 1 can supply stable power to the external device 100.

The printer 1 includes the print head 6, and the conveying unit 5 configured to convey the printing medium P. The CPU 30 is configured to perform a printing process (S52). In the printing process, the CPU 30 performs printing on the printing medium P by driving the print head 6 and the conveying unit 5. When the power supply start timing is set according to the first start condition and the CPU 30 determines that the connection state of the printer 1 to the AC adapter 101 meets the source setting condition during a printing process (S5: YES, S6: NO), the CPU 30 performs the power supply initiation process, i.e., outputs a source setting instruction to the PD circuit 84 to cause the PD circuit 84 to initiate the supply of power to the external device 100 (S10), after the printing process has been completed (S6: YES).

If the CPU 30 were to begin the supply of power during a printing process, the power supplied to the print head 6 could become temporarily unstable, resulting in poor print quality. Thus, the power supply initiation process executed by the CPU 30 of the printer 1 helps to avoid poor print quality caused by the CPU 30 initiating the supply of power to the external device 100 while a printing process is in progress.

The printer 1 includes the print head 6. When the power supply start timing is set according to the fifth start condition and the CPU 30 determines that the connection state of the printer 1 to the AC adapter 101 meets the source setting condition during driving of the print head 6, the CPU 30 performs the power supply initiation process, i.e., outputs a source setting instruction to the PD circuit 84 to cause the PD circuit 84 to initiate the supply of power to the external device 100 (S10), after the driving of the print head 6 has been completed (S6: YES).

If the CPU 30 were to begin the supply of power while during the driving of the print head 6, the power supplied to the print head 6 could become temporarily unstable, resulting in poor print quality. Thus, the power supply initiation process executed by the CPU 30 of the printer 1 helps to reduce such poor print quality caused by initiating the power supply to the external device 100 while the print head 6 is being driven.

The printer 1 includes the conveying unit 5 configured to convey a printing medium P. When the power supply start timing is set according to the sixth start condition and the CPU 30 determines that the connection state of the printer 1 to the AC adapter 101 meets the source setting condition during driving of the conveying unit 5, i.e., during conveyance of the printing medium P (S5: YES, S6: NO), the CPU 30 performs the power supply initiation process, i.e., outputs a source setting instruction to the PD circuit 84 to cause the PD circuit 84 to initiate the supply of power to the external device 100 (S10), after the driving of the conveying unit 5 has been completed, i.e., the conveyance of the printing medium P has been completed (S6: YES).

If the CPU 30 were to begin the supply of power during the driving of the conveying unit 5, power supplied to the conveying unit 5 could become temporarily unstable, resulting in poor conveying precision. Thus, the power supply initiation process executed by the CPU 30 of the printer 1 begins the supply of power to the external device 100 after the driving of the conveying unit 5 has been completed when the connection state of the printer 1 to the AC adapter 101 meets the source setting condition during the driving of the conveying unit 5, thereby reducing the possibility of poor conveying precision caused by initiating the supply of power to the external device 100 while the conveying unit 5 is being driven.

The printer 1 includes the cutting blade 54 configured to cut the printing medium P. After performing a printing process (S52), the CPU 30 executes a cutting process (S54) to cut the printing medium P by driving the cutting blade 54 while the conveying unit 5 is halted. When the power supply start timing is set according to the second start condition and the CPU 30 determines that the connection state of the printer 1 to the AC adapter 101 meets the source setting condition during a printing process (S5: YES, S6: NO), the CPU 30 performs the power supply initiation process after completing the printing process and during the cutting process (S6: YES). In the power supply initiation process, the CPU 30 outputs a source setting instruction to the PD circuit 84 to cause the PD circuit 84 to initiate the supply of power to the external device 100 (S10).

Thus, when the CPU 30 of the printer 1 determines that the connection state of the printer 1 to the AC adapter 101 meets the source setting condition while a printing process is in progress, in the power supply initiation process, the CPU 30 begins the supply of power to the external device 100 when executing the cutting process following completion of the printing process. Therefore, by performing the power supply initiation process, the CPU 30 can initiate the supply of power to the external device 100 without reducing print quality and conveyance quality.

When the power supply start timing is set according to the third start condition and the CPU 30 determines that the connection state of the printer 1 to the AC adapter 101 meets the source setting condition during a printing process (S5: YES, S6: NO), the CPU 30 performs the power supply initiation process, i.e., outputs a source setting instruction to the PD circuit 84 to start the supply of power to the external device 100 (S10) in between print jobs, i.e., after completing the current printing process and before a next printing process (S6: NO). Thus, since the CPU 30 of the printer 1 begins the supply of power to the external device 100 between print jobs in the power supply initiation process, the process restricts the power supply initiation process from interfering with the printing process.

The printer 1 includes the wireless communication interface 17. The CPU 30 is configured to perform a receiving process (S51) to receive a print instruction instructing to perform a printing process through the wireless communication interface 17. That is, the CPU 30 performs the printing process in response to receiving a print instruction through the wireless communication interface 17.

When the power supply start timing is set according to the fourth start condition and the CPU 30 determines that the connection state of the printer 1 to the AC adapter 101 meets the source setting condition during a printing process performed in response to receiving the print instruction (S5: YES, S6: NO), the CPU 30 performs the power supply initiation process, i.e., outputs a source setting instruction to the PD circuit 84 to cause the PD circuit 84 to initiate the supply of power to the external device 100 (S10) in between print jobs, i.e., after completing the printing process performed based on the current print instruction received through the wireless communication interface 17 and before receiving a next print instruction through the wireless communication interface 17 (S6: YES).

Thus, since the CPU 30 of the printer 1 initiates the supply of power to the external device 100 between print jobs in the power supply initiation process, the CPU 30 restricts the power supply initiation process from interfering with the printing process.

On the basis of the power state of the printer 1, the CPU 30 is configured to perform a power supply termination process, i.e., outputs a sink setting instruction to the PD circuit 84 to cause the PD circuit 84 to terminate the supply of power to the external device 100. The sink setting instruction instructs the PD circuit 84 to switch the power role of the printer 1 with respect to the external device 100 from source to sink (S23 or S33). Thus, by performing the power supply termination process, the CPU 30 of the printer 1 automatically stops the supply of power to the external device 100 in accordance with the power state of the printer 1.

In response to obtaining a power-off instruction instructing the CPU 30 to turn off the printer 1 (S21: YES), the CPU 30 performs the power supply termination process, i.e., outputs a sink setting instruction to the PD circuit 84 to stop the supply of power to the external device 100 (S23). Thus, by performing the power supply termination process, the CPU 30 of the printer 1 automatically stops the supply of power to the external device 100 when a power-off instruction is obtained.

When the CPU 30 determines that the AC adapter 101 has been disconnected from the printer 1 (i.e., the printer 1 has been disconnected from the external power source) (S31: YES), the CPU 30 performs the power supply termination process, i.e., outputs a sink setting instruction to the PD circuit 84 to cause the PD circuit 84 to terminate the supply of power to the external device 100 (S33). When the AC adapter 101, which has been connected to the printer 1, is disconnected from the printer 1 in a state where the printer 1 supplies power to the external device 100, the power supplied to the printer 1 becomes temporarily unstable. By automatically terminating the supply of power to the external device 100 in the power supply termination process executed by the CPU 30 of the printer 1 when the AC adapter 101 is disconnected from the printer 1, the CPU 30 restricts the power supplied to the printer 1 from becoming temporarily unstable.

The printer 1 includes the print head 6, and the conveying unit 5 configured to convey the printing medium P. The CPU 30 is configured to perform a printing process (S52) to perform printing on the printing medium P by driving the print head 6 and the conveying unit 5. When the power state of the printer 1 meets a condition for outputting a sink setting instruction during a printing process, the CPU 30 performs the power supply termination process, i.e., outputs a sink setting instruction to the PD circuit 84 to halt the supply of power to the external device 100 (S23 or S33), after the printing process has been completed (S22: NO or S32: NO).

When the power state of the printer 1 meets the condition for outputting a sink setting instruction (i.e., the condition for halting the supply of power to the external device 100) during a printing process, the power supplied to the printer 1 becomes temporarily unstable. Thus, when the CPU 30 of the printer 1 determines that the power state of the printer 1 meets the condition for outputting a sink setting instruction during a printing process, the CPU 30 performs the power supply termination process to automatically terminate the supply of power to the external device 100 after completion of the printing process, thereby restricting power supplied to the printer 1 from becoming temporarily unstable during a printing process.

The printer 1 includes the print head 6, and the conveying unit 5 configured to convey the printing medium P. The CPU 30 is configured to perform a printing process (S52) to perform printing on the printing medium P by driving the print head 6 and the conveying unit 5, and a power-off process (S25), when obtaining a power-off instruction, to turn off the printer 1. When the CPU 30 obtains the power-off instruction during a printing process, the CPU 30 performs the power-off process to turn off the power supply to the printer 1 after the printing process has been completed. Accordingly, the CPU 30 of the printer 1 restricts the printer 1 from being turned off during a printing process.

In the negotiation with the external device 100, the PD circuit 84 initially sets the power role of the printer 1 to sink. Thus, the PD circuit 84 of the printer 1 restricts the power supply to the external device 100 from being started during an unintended power state.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The present disclosure may be implemented in the form of a printing program executed by the processor of a printer, a non-transitory computer-readable medium storing the printing program, and a method of controlling a printer.

(A) The configuration of the printer 1 may be modified as appropriate. The printer 1 may or may not include the cutter unit 50 for cutting the printing medium P. The cutter unit 50 may be attached to the printer 1 so as not to be detachable from the printer 1. The type of printer 1 may be modified as appropriate. For example, the printer 1 may be an inkjet printer or a label printer.

The arrangement of the conveying unit 5 may be modified as appropriate in accordance with the configuration of the print head 6, and may not be arranged in a position in which the conveying unit 5 faces the print head 6. The conveying unit 5 may be configured of a conveying belt instead of a conveying roller. A plurality of conveying units 5 may be arranged in the printer 1. The printing medium P may be modified as appropriate. For example, the printing medium P may be tape that is not wound into a roll or may be fanfold paper. The printer 1 may include two or more USB connectors 82.

(B) The CPU 30 can perform the printing control process, the power supply initiation control process, and the power supply termination control process suitably as long as the programs containing commands to implement the printing control process, the power supply initiation control process, and the power supply termination control process are stored in a storage device of the printer 1 before the CPU 30 executes the programs. Therefore, each of the method of obtaining programs, the path for obtaining the programs, and the device that stores the programs may be modified as appropriate. The programs executed by the CPU 30 may also be received from another device through a cable or wireless communication and stored in a storage device. Examples of other devices include personal computers (PCs) and servers which are connected via a network.

(C) Although the CPU 30 executes each step of the printing control process, the power supply initiation control process, and the power supply termination control process in the embodiment, all or some of the steps may be executed by another electronic device (e.g., an ASIC). Alternatively, steps in the printing control process, the power supply initiation control process, and the power supply termination control process may be executed through distributed processing performed by a plurality of electronic devices (e.g., a plurality of CPUs). In other words, the processor of the printer 1 may be configured of a plurality of electronic devices.

Note that the term “processor” encompasses both a single processor or a group of multiple processors located either locally or remotely working together or in a distributed fashion to collectively perform the tasks attributed to the “processor” described herein.

Steps may also be added to or omitted from the printing control process, the power supply initiation control process, and the power supply termination control process, and the order of the steps may be modified as appropriate. The following modifications may be incorporated in the printing control process, the power supply initiation control process, and the power supply termination control process as appropriate.

The source setting condition may be modified as appropriate. In a case where the printer 1 includes a removable power supply battery for supplying power to the external device 100, the printer 1 determines that the source setting condition is met when the power supply battery is mounted in the printer 1 and stores sufficient power to be supplied to the external device 100.

The condition for setting the power supply start timing may be modified as appropriate and is not limited to the first through sixth start conditions described in the embodiment. For example, the printer 1 may obtain information on the remaining battery level of the external device 100 and may determine whether to prioritize power supply to the external device 100 based on the obtained battery level. The condition for setting the power supply start timing may also be selected by the user from a plurality of candidates. The CPU 30 may skip the process of S6 in the power supply initiation control process and may simply output a source setting instruction to the PD circuit 84 to begin the supply of power to the external device 100 (S10) when the source setting condition is met (S5: YES).

The process in which the CPU 30 outputs a sink setting instruction to the PD circuit 84 to switch the power role of the printer 1 with respect to the external device 100 from source to sink in accordance with the battery supply state may be modified as appropriate or omitted. The power state of the printer 1 that serves as the condition for outputting a sink setting instruction may be modified as appropriate. The CPU 30 may output a sink setting instruction in response to a user instruction inputted via the input unit 25.

In a case where the process of S23 is omitted, for example, the CPU 30 first halts the supply of power from the power supply DC/DC 81 to the external device 100 through the process of S24 and subsequently in S26 begins renegotiating with the external device 100 for returning the power role of the printer 1 to sink, which is an initial value of the power role of the printer 1, in S27. Similarly, in a case where the process of S33 is omitted, the CPU 30 first halts the supply of power from the power supply DC/DC 81 to the external device 100 through the process of S35 and subsequently begins a renegotiation in S36 for returning the power role of the printer 1 to sink, which is the initial value, in S37.

The initial power role of the printer 1 may be configured by the user. In a case where the initial power role of the printer 1 is set to source, for example, the CPU 30 may temporarily set the power role of the printer 1 to source during a negotiation when the external device 100 is connected and may automatically set the power role to sink at a prescribed timing thereafter. The prescribed timing may be a predetermined length of time after the power role has been set to source, for example. Alternatively, the prescribed timing may be the timing at which an instruction is obtained from the user in a state where the external device 100 is not connected to the USB connector 82 of the printer 1, for example.

### REMARKS

The printer 1 is an example of the “printer”. The USB connector 82 is an example of the “USB connector”. The external device 100 is an example of the “external device”. The PD circuit 84 is an example of the “PD circuit”. The CPU 30 is an example of the “processor”. The AC adapter 101 is an example of the “external power source”. The print head 6 is an example of the “print head”. The printing medium P is an example of the “printing medium”. The cutting blade 54 is an example of the “cutting blade”. The process in S10 is an example of the “power supply initiation process”. The process in S52 is an example of the “printing process”. The process in S54 is an example of the “cutting process”. The processes of S23 and S33 are each an example of the “power supply termination process”. The process of S25 is an example of the “power-off process”.

What is claimed is:

1. A printer comprising:
a Universal Serial Bus (USB) connector to which an external device is connectable;
a Power Delivery (PD) circuit configured to perform a negotiation with the external device according to a Universal Serial Bus Power Delivery (USB-PD) specification in a state where the external device is connected to the USB connector; and
a processor configured to perform:
a power supply initiation process on the basis of a power state of the printer, the power supply initiation process including outputting a source setting instruction to the PD circuit to cause the PD circuit to initiate supply of power to the external device, the source setting instruction instructing the PD circuit to switch a power role of the printer with respect to the external device from sink to source.

2. The printer according to claim 1,
wherein the processor performs the power supply initiation process when a connection state of the printer to an external power source meets a source setting condition.

3. The printer according to claim 2,
wherein the source setting condition is met when the printer is connected to the external power source in a state where the external device is connected to the USB connector.

4. The printer according to claim 2,
wherein the source setting condition is met when the external device is connected to the USB connector in a state where the printer is connected to the external power source.

5. The printer according to claim 2, further comprising:
a print head,
wherein the processor is configured to further perform:
a printing process including printing on a printing medium by driving the print head, and
wherein, when the connection state meets the source setting condition during the printing process, the processor performs the power supply initiation process after the printing process has been completed.

6. The printer according to claim 2, further comprising:
a print head,
wherein, when the connection state meets the source setting condition during driving of the print head, the processor performs the power supply initiation process after the driving of the print head has been completed.

7. The printer according to claim 2,
wherein, when the connection state meets the source setting condition during conveyance of a printing medium, the processor performs the power supply initiation process after the conveyance of the printing medium has been completed.

8. The printer according to claim 5, further comprising:
a cutting blade,
wherein the processor is configured to further perform:
a cutting process after the printing process has been completed, the cutting process including cutting a printing medium by driving the cutting blade, and
wherein, when the connection state meets the source setting condition during the printing process, the processor performs the power supply initiation process during the cutting process.

9. The printer according to claim 5,
wherein, when the connection state meets the source setting condition during the printing process, the processor performs the power supply initiation process after the printing process has been completed and before a next printing process.

10. The printer according to claim 5, further comprising:
a wireless communication interface,
wherein the processor performs the printing process in response to receiving a print instruction through the wireless communication interface, and
wherein, when the connection state meets the source setting condition during the printing process performed in response to receiving the print instruction, the processor performs the power supply initiation process after the printing process has been completed and before receiving a next print instruction through the wireless communication interface.

11. The printer according to claim 1,
wherein the processor is configured to further perform:
a power supply termination process on the basis of the power state of the printer, the power supply termination process including outputting a sink setting instruction to the PD circuit to cause the PD circuit to terminate the supply of power to the external device, the sink setting instruction instructing the PD circuit to switch the power role of the printer from source to sink.

12. The printer according to claim 11,
wherein the processor performs the power supply termination process in response to obtaining a power-off instruction, the power-off instruction instructing the processor to turn off the printer.

13. The printer according to claim 11,
wherein the processor performs the power supply termination process when the printer is disconnected from an external power source.

14. The printer according to claim 11, further comprising:
a print head,
wherein the processor is configured to further perform:
a printing process including printing on a printing medium by driving the print head, and
wherein, when the power state of the printer meets a condition for outputting the sink setting instruction during the printing process, the processor performs the power supply termination process after the printing process has been completed.

15. The printer according to claim 11, further comprising:
a print head,
wherein the processor is configured to further perform:
a printing process including printing on a printing medium by driving the print head; and
a power-off process when obtaining a power-off instruction, the power-off process including turning off the printer, and
wherein, when obtaining the power-off instruction during the printing process, the processor performs the power-off process after the printing process has been completed.

16. The printer according to claim 1,
wherein, in the negotiation with the external device, the PD circuit initially sets the power role of the printer to sink.
